(19) United States
(12) Patent Application Publication
(10) Pub. No.: US 2009/0015121 A1
(43) Pub. Date: Jan. 15, 2009

(54) Medicine Cabinet Safe Systems

(76) Inventor: Carol Ann Sampson, Phoenix, AZ (US)

Correspondence Address: Stoneman Volk Patent Group, 3770 NORTH 7TH STREET, Suite 100, PHOENIX, AZ, 85014, US

(21) Appl. No.: 12/170,980

(22) Filed: Jul. 10, 2008

Related U.S. Application Data
(60) Provisional application No. 60/949,148, filed on Jul. 11, 2007.

(51) Int. Cl. A47B 67/02; E05G 1/024

(52) U.S. Cl. 312/242; 109/58

(57) ABSTRACT

A system relating to safely and securely storing medications in a wall-mounted medicine cabinet by providing a lockable safe permanently mounted in the medicine cabinet. This system also provides for adjustable shelves within the medicine cabinet both inside and outside of the safe. Further, this system provides for a variety of placements of a safe within a medicine cabinet; and, this variety adds to the selectable options of the user.

### CROSS-REFERENCE TO RELATED APPLICATION

The present application is related to and claims priority from prior provisional application Ser. No. 60/949,148, filed Jul. 11, 2007, entitled “MEDICINE CABINET SAFE SYSTEMS”, the contents of which is incorporated herein by this reference and is not admitted to be prior art with respect to the present invention by the mention in this cross-reference section.

### BACKGROUND

This invention relates to providing medicine cabinet safe systems. More particularly, this invention relates to providing a system for safely and securely storing medications in a medicine cabinet.

Typically, medications stored in a medicine cabinet are accessible by anyone in the home, including small children and potential thieves. Children, who are naturally curious, may gain possession of medications stored in a medicine cabinet and ingest a harmful substance resulting in sickness or death.

Additionally, visitors to the home or business and potential drug medication thieves may have easy access to medications with high street value that might be found in a medicine cabinet. Theft of medications, which are often expensive to replace, may deny the prescribed person the use of such medications, leading to a potentially harmful situation. There are many incidences of medicine cabinet drug misuse by unauthorized access to such medicine cabinets and many other related safety problems relating to medicine cabinet storage.

### OBJECTS AND FEATURES OF THE INVENTION

A primary object and feature of the present invention is to provide a system overcoming the above-mentioned problems.

It is a further object and feature of the present invention to provide such a system that secures medications and other medical items against unauthorized use.

It is a further object and feature of the present invention to provide such a system that secures medications and other medical items against theft.

It is a further object and feature of the present invention to provide such a system that secures medications and other medical items against accidental use by children.

It is a further object and feature of the present invention to provide such a system providing a lockable medicine safe permanently mounted in a medicine cabinet.

It is a further object and feature of the present invention to provide such a system providing a lockable medicine safe with adjustable shelving.

It is a further object and feature of the present invention to provide such a system providing a lockable medicine safe permanently attached interior to a medicine cabinet.

It is a further object and feature of the present invention to provide such a system providing a medicine cabinet comprising a lockable medicine safe that does not appear unique from the exterior of the medicine cabinet.

A further primary object and feature of the present invention is to provide such a system that is efficient and handy. Other objects and features of this invention will become apparent with reference to the following descriptions.

### SUMMARY OF THE INVENTION

In accordance with a preferred embodiment hereof, this invention provides a medicine cabinet safe system, relating to such system permanently mountable on at least one wall of at least one structure, comprising: medicine cabinet means for providing at least one medicine cabinet; lockable safe means for safely storing items; safe mount means for permanent mounting of such lockable safe means within such medicine cabinet means; and wall mount means for permanent mounting of such medicine cabinet means to the at least one wall.

In accordance with another preferred embodiment hereof, this invention provides a medicine cabinet safe system, relating to such system permanently mountable on at least one wall of at least one structure, comprising: at least one medicine cabinet; at least one lockable safe structured and arranged to safely store items; at least one safe mount structured and arranged to permanently mount such at least one lockable safe within such at least one medicine cabinet; and at least one wall mount structured and arranged to permanently mount such at least one medicine cabinet to the at least one wall.

Moreover, it provides such a medicine cabinet safe system wherein such at least one wall mount comprises: at least one fastener adapted to firmly attach such at least one lockable safe and such at least one medicine cabinet to the at least one wall; and wherein such at least one lockable safe and such at least one medicine cabinet are adapted to be penetrated and held in position by such at least one fastener. Additionally, it provides such a medicine cabinet safe system wherein such at least one fastener comprises: at least one threadable fastener; wherein such at least one threadable fastener is threadable into at least one framing stud of the at least one wall; wherein such at least one threadable fastener may be fastened only from within such at least one lockable safe.

Also, it provides such a medicine cabinet safe system wherein such wall mount further comprises: at least one framing-stud reinforcement structured and arranged to reinforce the integrity of such at least one framing stud, when attached to such at least one framing stud, wherein such at least one threadable fastener and such at least one framing stud reinforcement are structured and arranged so that such at least one threadable fastener, when attached with such at least one framing stud, will penetrate such at least one framing stud reinforcement.

In addition, it provides such a medicine cabinet safe system wherein such at least one lockable safe comprises at least one safe shelf structured and arranged to support such items, when such items are placed upon such at least one safe shelf. And, it provides such a medicine cabinet safe system wherein such at least one safe shelf is adjustable. Further, it provides such a medicine cabinet safe system wherein such at least one lockable safe comprises at least one keyed lock, structured and arranged to lock such at least one lockable safe. Even further, it provides such a medicine cabinet safe system wherein such at least one lockable safe comprises at least one electronic-keypad lock structured and arranged to lock such at least one lockable safe. In addition, it provides such a medicine cabinet safe system wherein such at least one lockable safe comprises at least one tumbler lock structured and arranged to lock such at least one lockable safe. Moreover, it provides such a medicine cabinet safe system wherein such at least one lockable safe comprises at least one fingerprint lock structured and arranged to lock such at least one lockable safe.

Additionally, it provides such a medicine cabinet safe system wherein such at least one lockable safe encloses about one-third of at least one interior of such at least one medicine cabinet. Also, it provides such a medicine cabinet safe system wherein such at least one lockable safe comprises at least one safe shelf structured and arranged to support such items. In addition, it provides such a medicine cabinet safe system wherein such at least one safe shelf is adjustable. And, it provides such a medicine cabinet safe system wherein such at least one lockable safe substantially encloses at least one central portion of the interior of such at least one medicine cabinet. Further, it provides such a medicine cabinet safe system wherein such at least one lockable safe comprises at least one safe shelf structured and arranged to support such items. Even further, it provides such a medicine cabinet safe system wherein such at least one safe shelf is adjustable.

Moreover, it provides such a medicine cabinet safe system wherein such at least one lockable safe encloses about one-half of the interior of such at least one medicine cabinet. Additionally, it provides such a medicine cabinet safe system wherein such at least one lockable safe comprises at least one safe shelf structured and arranged to support such items. Also, it provides such a medicine cabinet safe system wherein such at least one safe shelf is adjustable. In addition, it provides such a medicine cabinet safe system wherein such at least one lockable safe substantially encloses at least one upper portion of the interior of such at least one medicine cabinet. And, it provides such a medicine cabinet safe system wherein such at least one lockable safe comprises at least one safe shelf structured and arranged to support such items. Further, it provides such a medicine cabinet safe system wherein such at least one safe shelf is adjustable.

Even further, it provides such a medicine cabinet safe system wherein such at least one lockable safe substantially encloses at least one lower portion of the interior of such at least one medicine cabinet. Moreover, it provides such a medicine cabinet safe system wherein such at least one lockable safe comprises at least one safe shelf structured and arranged to support such items. Additionally, it provides such a medicine cabinet safe system wherein such at least one safe shelf is adjustable.

Also, it provides such a medicine cabinet safe system wherein such at least one lockable safe substantially encloses at least one upper portion of the interior of such at least one medicine cabinet. In addition, it provides such a medicine cabinet safe system wherein such at least one lockable safe substantially encloses at least one lower portion of the interior of such at least one medicine cabinet. And, it provides such a medicine cabinet safe system wherein such at least one lockable safe substantially encloses at least one central portion of the interior of such at least one medicine cabinet.

Further, it provides such a medicine cabinet safe system wherein such at least one medicine cabinet comprises substantially metal. Even further, it provides such a medicine cabinet safe system wherein such at least one lockable safe comprises substantially metal.

Even further, it provides such a medicine cabinet safe system: wherein such at least one medicine cabinet is substantially metal; wherein such at least one lockable safe is substantially metal; wherein such at least one medicine cabinet is about 17⅜″ wide, about 23″ high and about 5″ deep; wherein such at least one medicine cabinet comprises at least one shelf structured and arranged to support additional items, wherein such at least one shelf is adjustable wherein such at least one lockable safe comprises at least one keyed lock structured and arranged to lock such at least one lockable safe.

Even further, it provides such a medicine cabinet safe system: wherein such at least one medicine cabinet comprises substantially metal; wherein such at least one lockable safe comprises substantially metal; wherein such at least one medicine cabinet about 17⅜″ wide, about 23″ high and about 5″ deep; wherein such at least one medicine cabinet comprises at least one shelf structured and arranged to support additional items, wherein such at least one shelf is adjustable, wherein such at least one lockable safe comprises: at least one keyed lock structured and arranged to lock such at least one lockable safe.

In accordance with another preferred embodiment hereof, this invention provides a medicine cabinet-safe method comprising the steps of: providing a line of medicine cabinets each including at least one lockable safe located within and permanently mounted to at least one interior of at least one medicine cabinet of such line; wherein such line includes a plurality of selectable sizes of such lockable safes and a plurality of selectable placements of such lockable safes within such at least one medicine cabinet; receiving at least one order from at least one customer for such at least one medicine cabinet of such line; and providing such ordered at least one medicine cabinet to such at least one customer. Even further, it provides such a method further comprising the step of receiving, from such at least one customer, compensation for such ordered at least one medicine cabinet. Even further, it provides such a method wherein such line further includes a plurality of selectable locks relating to such lockable safes.

### BRIEF DESCRIPTION OF THE DRAWINGS

FIG. 1 shows a perspective view, illustrating a medicine cabinet safe of the medicine cabinet safe system recess-mounted in a wall, according to a preferred embodiment of the present invention.

FIG. 2 shows a front view, illustrating the medicine cabinet safe, according to the preferred embodiment of FIG. 1.

FIG. 3 shows an enlarged front-view, illustrating the medicine cabinet safe, according to the preferred embodiment of FIG. 1.

FIG. 4 shows a sectional view, through the section 4-4 of FIG. 3, according to the preferred embodiment of FIG. 1.

FIG. 5 shows a partial exploded perspective-view, illustrating a security mount of the medicine cabinet safe, according to the preferred embodiment of FIG. 1.

FIG. 6 shows a front view, illustrating another medicine cabinet safe, according to an alternate preferred embodiment of the present invention.

FIG. 7 shows a front view, illustrating yet another medicine cabinet safe, according to an alternate preferred embodiment of the present invention.

FIG. 8A shows a partial front-view, of yet another medicine cabinet safe, illustrating another locking system, according to an alternate preferred embodiment of the present invention.

FIG. 8B shows a partial front-view, of yet another medicine cabinet safe, illustrating yet another locking system, according to an alternate preferred embodiment of the present invention.

FIG. 9 shows a partial front-view, of yet another medicine cabinet safe, illustrating yet another locking system, according to an alternate preferred embodiment of the present invention.

FIG. 10 shows a side cut-away view of yet another medicine cabinet safe, mounted on a wall, illustrating another security mounting system, according to an alternate preferred embodiment of the present invention.

FIG. 11 shows a side cut-away view, of yet another medicine cabinet safe according to an alternate preferred embodiment of the present invention.

### DETAILED DESCRIPTION OF THE BEST MODES AND PREFERRED EMBODIMENTS OF THE INVENTION

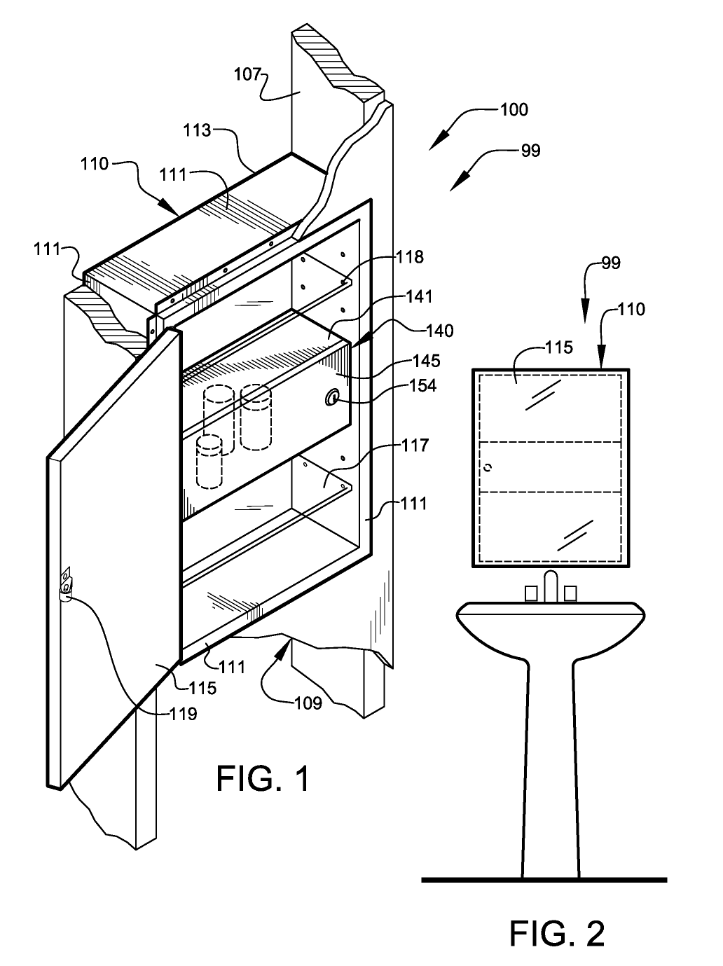

FIG. 1 shows a perspective view, illustrating a medicine cabinet safe 99 of medicine cabinet safe system 100 recess-mounted into a wall 109, according to a preferred embodiment of the present invention. At least one medicine cabinet 110 is preferably sized for in-home use, preferably dimensioned about 14-inches wide, about 24-inches high and about 4-inches deep, as shown. Upon reading this specification, those with ordinary skill in the art will now appreciate that, under appropriate circumstances, considering such issues as design preference, user preferences, marketing preferences, cost, structural requirements, available materials, technological advances, etc., other dimensions such as, for example, longer, shorter, wider, thinner, deeper, etc., may suffice.

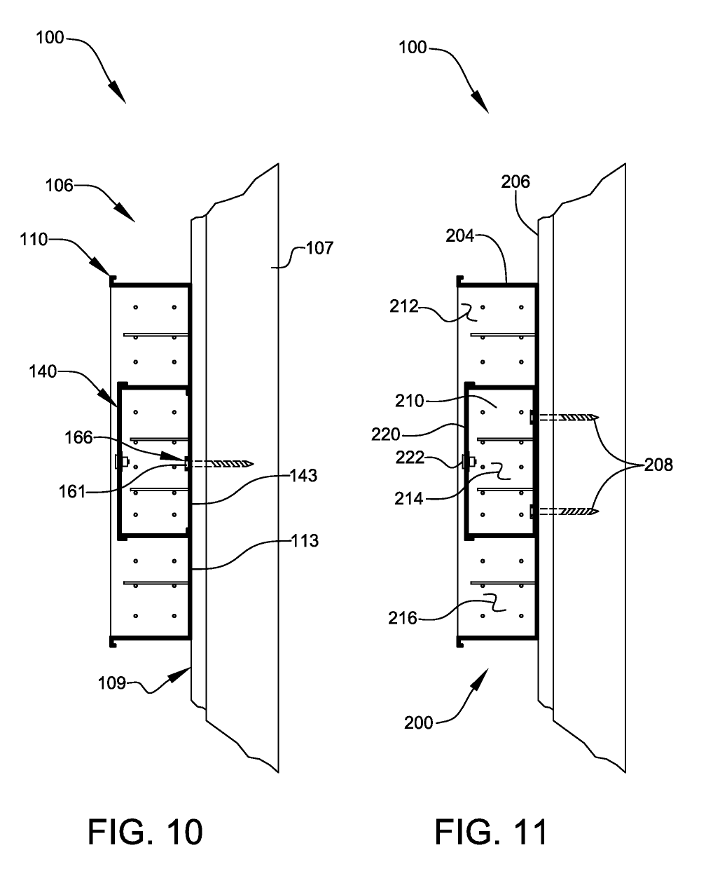

Medicine cabinet 110 preferably mounts to wall 109, preferably either recessed adjacent to at least one framing stud 107, as shown in FIG. 1, or alternately preferably attached directly onto wall 109 (see FIG. 10). Medicine cabinet 110 preferably comprises: four walls, preferably comprising cabinet wall 111; preferably cabinet back 113; cabinet door 115; and lockable safe 140, as shown. Upon reading this specification, those with ordinary skill in the art will now appreciate that, under appropriate circumstances, considering such issues as design preference, user preferences, marketing preferences, cost, structural requirements, available materials, technological advances, etc., other safe arrangements such as, for example, multiple safes, etc., may suffice.

Cabinet wall 111, cabinet back 113, cabinet door 115, and lockable safe 140 are preferably made from metal, preferably steel, preferably coated steel, preferably rust-inhibitive steel (this arrangement at least embodies herein wherein such at least one medicine cabinet comprises substantially metal; and also at least embodying herein wherein such at least one lockable safe comprises substantially metal). Upon reading this specification, those with ordinary skill in the art will now appreciate that, under appropriate circumstances, considering such issues as cost, structural requirements, available materials, future medical needs, etc., other-than-metal medicine cabinet structure parts (including safe parts) using materials such as, for example, plastics, hardwoods, carbon-fiber, etc., may suffice.

Preferably, cabinet door 115 is attached to medicine cabinet 110, preferably using at least one hinge. A cabinet latch 119 is preferably attached to cabinet door 115, shown open in FIG. 1. In operation, when engaged, cabinet latch 119 preferably holds cabinet door 115 in a closed position. In a preferred embodiment a mirror is attached to cabinet door 115, preferably a tempered glass mirror, as shown. Upon reading this specification, those with ordinary skill in the art will now appreciate that, under appropriate circumstances, considering such issues as design preference, user preferences, marketing preferences, cost, structural requirements, available materials, technological advances, etc., other mirror arrangements such as, for example, high gloss metal, non-tempered glass, etc., may suffice.

Medicine cabinet 110 is preferably used for storage of items, including medicines or other items that a user prefers to keep locked up. Medicine cabinet 110 preferably comprises lockable safe 140, which assists preventing unauthorized access to those items preferred to be kept locked. Lockable safe 140 is preferably manufactured as part of medicine cabinet 110, preferably comprising a unitary structure with medicine cabinet 110, as shown. Medicine cabinet 110 preferably completely contains, within its confines, lockable safe 140 (at least embodying herein lockable safe means for safely storing items; and also at least one lockable safe, preferably structured and arranged to safely store items), as shown.

Additionally, medicine cabinet 110 preferably contains at least one shelf 117, preferably outside of lockable safe 140 for storage of additional items, as shown. Shelf 117 preferably rests upon at least one shelf support 118. Shelf support 118 is preferably attachable to cabinet wall 111, preferably using shelf pins, as shown. Cabinet wall 111 preferably accepts attachment of such at least one shelf support 118 in multiple places, preferably using drilled holes typical of shelf pin adjustable shelving, as shown. Upon reading this specification, those with ordinary skill in the art will now appreciate that, under appropriate circumstances, considering such issues as cost, structural requirements, available space, future medical needs, etc., use of other-than-adjustable shelves such as, for example, fixed, replaceable, partially adjustable, removable, etc., may suffice.

FIG. 2 shows a front view, illustrating the medicine cabinet safe 99, according to the preferred embodiment of FIG. 1. Cabinet door 115 is closed to preferably conceal the presence of lockable safe 140. Medicine cabinet 110 preferably outwardly appears like an ordinary medicine cabinet when cabinet door 115 is closed, as shown.

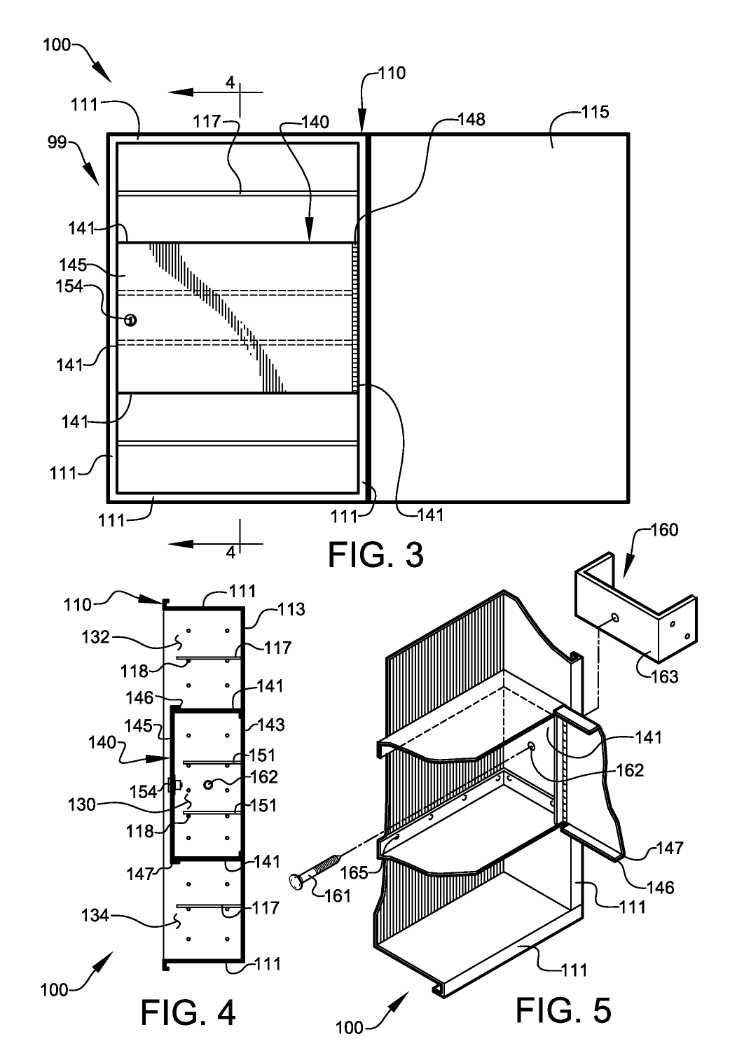

FIG. 3 shows an enlarged front-view, illustrating the medicine cabinet safe 99 of medicine cabinet safe system 100, according to the preferred embodiment of FIG. 1. As shown in FIG. 3, lockable safe 140 preferably consists of: four walls, one upper safe wall 141, two cabinet side walls 111; safe door 145; and as shown in FIG. 4, safe back 143, preferably being at least one portion of cabinet back 113, as shown. Upon reading this specification, those with ordinary skill in the art will now appreciate that, under appropriate circumstances, considering such issues as cost, manufacturing requirements, safe structure position, safe structure size, consumer requirements, etc., incorporating as safe walls other medicine cabinet structure parts such as, for example, other safe structures, additional cabinet walls, fixed shelves, etc., may suffice. Preferably, a continuous hinge 148 attaches safe door 145 to lockable safe 140, as shown. At least one lock 154 is preferably attached to safe door 145, as shown. Lock 154 preferably comprises at least one keyed cylindrical lock 154 (at least embodying herein wherein such at least one lockable safe comprises at least one keyed lock structured and arranged to lock such at least one lockable safe). When engaged, lock 154 preferably secures safe door 145 from being opened without authorized access, such as an authorized key.

Lockable safe 140 preferably spans the width of the interior of medicine cabinet 110, as shown. Lockable safe 140 preferably encloses about one-third of the available interior 132 of medicine cabinet 110, preferably comprising at least one upper interior portion 132, at least one middle interior portion 130 and, at least one lower interior portion 134, as shown. Lockable safe 140 preferably substantially encloses at least one middle interior portion 130 (this arrangement at least embodying herein wherein such at least one lockable safe encloses about one-third of at least one interior of such at least one medicine cabinet) of medicine cabinet 110, as shown (this arrangement at least embodying herein wherein such at least one lockable safe substantially encloses at least one central portion of the interior of such at least one medicine cabinet).

FIG. 4 shows a sectional view, through the section 4-4 of FIG. 3, according to the preferred embodiment of FIG. 1. Preferably each safe wall 141 is integrally mounted to safe back 143, preferably by welding and, preferably each safe wall 141 is welded to each adjoining safe wall 141 so as to preferably construct a unitary box with an open front that has essentially welded joints 165 (at least embodying herein at least one safe attacher structured and arranged to permanently attach said at least one lockable safe within said at least one medicine cabinet). In other words, lockable safe 140 is welded to medicine cabinet 110 making lockable safe 140 preferably unitary to medicine cabinet 110, as shown. Upon reading this specification, those with ordinary skill in the art will now appreciate that, under appropriate circumstances, considering such issues as materials, cost, available bonding materials, manufacturing requirements, security, etc., other unitary joints using materials such as, for example, chemical bonds, rivets, non-removable screws, etc., may suffice.

Safe door 145 preferably mechanically engages each safe wall 141 with at least one right-angle fold 147 of safe door edge 146, as shown. The above described mechanical engagement preferably creates mechanical fusing of such safe door 145 to the rest of lockable safe 140, as shown. Mechanical fusing preferably prevents unauthorized access that might occur by use of a pry bar to pry off safe door 145 or a respective safe wall 141.

Lockable safe 140 comprises preferably at least one adjustable safe shelf 151 (at least embodying herein wherein such at least one lockable safe comprises at least one safe shelf structured and arranged to support such items, when such items are placed upon such at least one safe shelf; and also wherein such shelf is adjustable), as shown. Upon reading this specification, those with ordinary skill in the art will now appreciate that, under appropriate circumstances, considering such issues as cost, structural requirements, available space, future medical needs, etc., use of other-than-adjustable safe shelves such as, for example, fixed, replaceable, partially adjustable, removable, etc., may suffice.

To sufficiently allow for thickness of cabinet back 113 and locking mechanism clearance of cabinet door 115, lockable safe 140 is preferably shallower in depth than medicine cabinet 110, as shown. Differences of depth between lockable safe 140 and medicine cabinet 110 is preferably greater than the sum of the thickness of cabinet back 113 and the clearance requirements of such lock 154, as shown.

Preferably, at least one security fastener hole 162 is drilled through at least one safe wall 141 and correspondingly through cabinet side wall 111 to assist penetration of security lag screw 161, for integrally fastening lockable safe 140 and medicine cabinet 110 to a wall through the cabinet side wall 111 (such penetration arrangement at least embodying herein wherein such at least one lockable safe and such at least one medicine cabinet are adapted to be penetrated and held in position by such at least one fastener). Upon reading of this specification, those with ordinary skill in the art will now appreciate that, under appropriate circumstances, considering such issues as manufacturing requirements, cost, materials, etc., other-than-drilled security lag-screw holes such as, for example, punched, bored, molded, cut, etc., may suffice.

FIG. 5 shows a partial exploded perspective-view illustrating a security mount 160 of medicine cabinet safe 99, according to the preferred embodiment of FIG. 1.

Preferably, security mount 160 (at least embodying herein wall mount means for permanent mounting of such medicine cabinet means to the at least one wall; and also at least one wall mount structured and arranged to permanently mount such at least one medicine cabinet to the at least one wall) provides added security when medicine cabinet 110 is mounted on a wall 109, as shown. Preferably, in addition to the use of ordinary mounting hardware, at least one security lag screw 161 (at least embodying herein at least one fastener adapted to firmly attach such at least one lockable safe and such at least one medicine cabinet to the at least one wall; and also at least one threadable fastener) is preferably threadably inserted through security fastener hole 162 and reinforcement plate 163, preferably into at least one framing stud 107 (this arrangement at least embodying herein wherein such at least one threadable fastener is threadable into at least one framing stud of the at least one wall). Upon reading this specification, those with ordinary skill in the art will now appreciate that, under appropriate circumstances, considering such issues as cost, availability of materials, installation requirements, etc., alternatives to lag-screw security-mounts using parts such as, for example, bolts, pins, nails, etc., may suffice.

Preferably, security fastener hole 162 is sized so that security lag screw 161 will thread tightly through it. A reinforcement plate 163, preferably a steel metal plate, preferably between about ⅛-inch and about ¼-inch in thickness, is placed around a framing stud 107, as shown. Reinforcement plate 163 (at least embodying herein at least one framing-stud reinforcement structured and arranged to reinforce the integrity of such at least one framing stud, when attached to such at least one framing stud) preferably provides additional reinforcing to framing stud 107 so that security lag screw 161 is secured to the framing stud 107 and cannot be easily removed by pulling or prying. Upon reading this specification, those with ordinary skill in the art will now appreciate that, under appropriate circumstances, considering such issues as cost, installation requirements, materials available, etc., other than-herein-preferred framing-stud reinforcements using parts such as, for example, hole liners, wraps, heavy-duty studs, coatings, etc., may suffice.

Upon reading this specification, those with skill in the art will now appreciate that, under appropriate circumstances, considering such issues as cost, installation requirements, available materials, etc., other-than-metal securing plates using materials such as, for example, plastics, fiberglass, hardwoods, etc., may suffice.

Additional lag screws may be used to secure medicine cabinet 110, but lockable safe 140 preferably contains such at least one such security lag screw 161, as shown, when such at least one medicine cabinet 110 is mounted to wall 109. Placement of security lag screw 161, inside lockable safe 140, as shown in FIG. 5, preferably prevents removal of one medicine cabinet 110 from wall 109 without access to the inside of lockable safe 140 (this arrangement at least embodying herein wherein such at least one threadable fastener may be fastened only from within such at least one lockable safe).

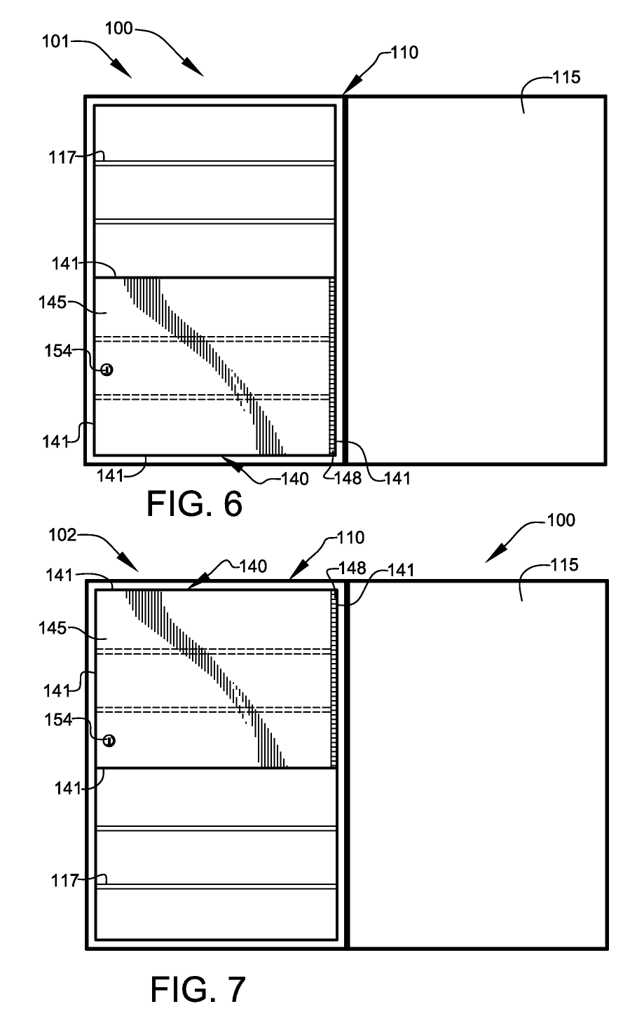

FIG. 6 shows a front view, illustrating another medicine cabinet safe 101, according to an alternate preferred embodiment of the present invention. Preferably, features of medicine cabinet safe 101 are repeated from preferred medicine cabinet safe 99, in medicine cabinet safe 101, as shown, except lockable safe 140 preferably substantially encloses at least one lower portion of the interior of medicine cabinet 110 (this arrangement at least embodying herein wherein such at least one lockable safe substantially encloses at least one lower portion of the interior of such at least one medicine cabinet). Lockable safe 140 preferably encloses about one-half of the available interior space of such at least one medicine cabinet 110.

FIG. 7 shows a front view, illustrating yet another medicine cabinet safe 102, according to an alternate preferred embodiment of the present invention. Preferably, features of medicine cabinet safe 102 are repeated from preferred medicine cabinet safe 99, in medicine cabinet safe 102, as shown, except lockable safe 140 preferably substantially encloses at least one upper portion of the interior of such medicine cabinet 110 (this arrangement at least embodying herein wherein such at least one lockable safe substantially encloses at least one upper portion of the interior of such at least one medicine cabinet). Upon reading this specification, those with ordinary skill in the art will now appreciate that, under appropriate circumstances, considering such issues as cost, consumer requirements, future medical requirements, etc., other placements of the fixed safe structures such as, for example, left side, right side, center, corner, etc., may suffice. Lockable safe 140 preferably encloses about one-half of available interior space of medicine cabinet 110 (this arrangement at least embodying herein wherein such at least one lockable safe encloses about one-half of the interior of such at least one medicine cabinet). Upon reading this specification, those with ordinary skill in the art will now appreciate that, under appropriate circumstances, considering such issues as cost, consumer requirements, future medical requirements, etc., other sizes of the fixed safe structures such as, for example, single-shelf-height, full-height, quarter-height, half-span, etc., may suffice.

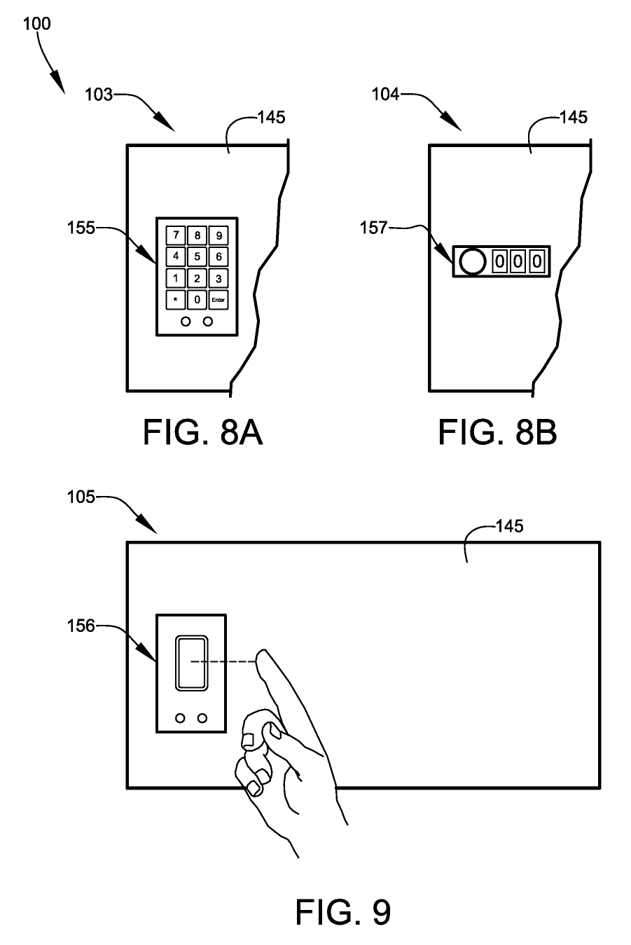

FIG. 8A shows a partial front view, of yet another medicine cabinet safe 103, illustrating another locking arrangement according to an alternate preferred embodiment of the present invention. Preferably, all features of medicine cabinet safe 103 are repeated from preferred medicine cabinet safe 99, in medicine cabinet safe 103, except for the lock being preferably at least one electronic-keypad locking device 155 (at least embodying herein wherein such at least one lockable safe comprises at least one electronic-keypad lock structured and arranged to lock such at least one lockable safe), as shown, secures safe door 145.

FIG. 8B shows a partial front view, of yet another medicine cabinet safe 104, illustrating another locking arrangement according to an alternate preferred embodiment of the present invention. Preferably, all features of medicine cabinet safe 104 are repeated from preferred medicine cabinet safe 99, in medicine cabinet safe 104, except for the lock being preferably at least one tumbler locking device 157 (at least embodying herein wherein such at least one lockable safe comprises at least one tumbler lock structured and arranged to lock such at least one lockable safe), as shown, secures safe door 145.

FIG. 9 shows a partial front view, of yet another medicine cabinet safe 105, illustrating yet another locking arrangement according to an alternate preferred embodiment of the present invention. Preferably, all features of medicine cabinet safe 105 are repeated from preferred medicine cabinet safe 99, in medicine cabinet safe 105 except for the lock being preferably at least one fingerprint locking device 156 (at least embodying herein wherein such at least one lockable safe comprises at least one fingerprint lock structured and arranged to lock such at least one lockable safe), as shown, secures safe door 145. Upon reading this specification, those with skill in the art will now appreciate that, under appropriate circumstances, considering such issues as cost, security, consumer requirements, etc., other locking systems such as, for example, tumbler, combination, voice recognition, padlock, retinal scan, etc., may suffice.

FIG. 10 shows a side cut-away view, of yet another medicine cabinet safe 106 mounted on a wall, illustrating another security mounting 166, according to an alternate preferred embodiment of the present invention. Preferably, features of medicine cabinet safe 106 are repeated from preferred medicine cabinet safe 99, except in medicine cabinet safe 106 on-wall-mounting preferably includes security mounting 166, as shown. Preferably, at least one security fastener hole 165, is drilled preferably through such at least one safe back 143 and correspondingly cabinet back 113, as shown. Security fastener hole 165 is preferably sized to snuggly fit such at least one security lag screw 161. In addition to the use of ordinary mounting hardware, security lag screw 161 is preferably threadable through security fastener hole 165 and wall 109, and into framing stud 107, when one medicine cabinet 110 is mounted on wall 109, as shown.

FIG. 11 shows a side cut-away view, of yet another medicine cabinet safe 200 of the medicine cabinet safe system 100 according to an alternate preferred embodiment of the present invention. Medicine cabinet safe 200 preferably comprises a fully enclosed safe unit 202, preferably fully enclosed in a medicine cabinet 204, as shown. Safe unit 202 is preferably permanently attached along with medicine cabinet 204 to a vertical wall portion 206, as shown. Preferably, safe unit 202 is through-bolted with at least two lag screws 208, alternately preferably four lag screws 208, preferably placed from the interior 210 of safe unit 202 through to the exterior of medicine cabinet 204, as shown. In such manner, safe unit 202 may be placed by a user in a preferred position in medicine cabinet 204. Safe unit 202 may be placed in the upper portion 212, middle portion 214, or lower portion 216. Illustrated in FIG. 11 safe unit 202 is placed in middle portion 214. Upon reading this specification, those with ordinary skill in the art will now appreciate that, under appropriate circumstances, considering such issues as design preference, user preferences, marketing preferences, cost, structural requirements, available materials, technological advances, etc., other placement arrangements such as, for example, more than one safe, placement in any user preferred position, etc., may suffice.

Safe unit 202 is preferably comprised of steel, preferably about ¼-inch to ½-inch in thickness. As described above in relation to other embodiments of the present invention, safe unit 202 comprises a hinged safe door 220, as shown. Preferably, hinged safe door 220 comprises at least one lock 222, as shown. Lock 222 is preferably selected from a keyed lock, a tumbler lock, an electronic lock, or a fingerprint identifying lock. Upon reading this specification, those with ordinary skill in the art will now appreciate that, under appropriate circumstances, considering such issues as design preference, user preferences, marketing preferences, cost, structural requirements, available materials, technological advances, etc., other lock arrangements may suffice.

In use, the system 100 preferably comprises at least one method of providing at least one medicine cabinet safe, described herein, to at least one customer. Such method comprises the step of providing a line of medicine cabinets 110, each preferably including at least one lockable safe 140 preferably located within, and permanently mounted to, at least one interior of at least one medicine cabinet 110 of such medicine cabinet line. Medicine cabinet line preferably comprises a plurality of selectable sizes of at least one lockable safe 140 and a plurality of selectable placements of at least one lockable safe 140 within at least one medicine cabinet 110 [see FIGS. 3, 6, & 7]. Medicine cabinet line preferably comprises a choice of at least one plurality of selectable locks relating to such lockable safes [see FIGS. 3, 8, & 9].

In a preferred method of selling the medicine cabinet line, a method is preferred comprising the step of receiving at least one order from at least one customer for such at least one medicine cabinet 110 of such line. Further, such method preferably comprises the step of providing such ordered of at least one medicine cabinet 110 by such at least one customer. Additionally, such method may comprise the step of receiving, from such at least one customer, compensation for such ordered medicine cabinet 110.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A medicine cabinet safe system, relating to such system permanently mountable on at least one wall of at least one structure, comprising:
a) at least one medicine cabinet having at least one interior enclosable portion comprising,
i) at least one upper interior portion,
ii) at least one middle interior portion, and
iii) at least one lower interior portion;
b) at least one lockable safe structured and arranged to safely store items;
c) at least one safe attacher structured and arranged to permanently attach said at least one lockable safe within said at least one interior enclosable portion of said at least one medicine cabinet; and
d) at least one wall mount structured and arranged to assist permanent mounting of said at least one medicine cabinet and said at least one lockable safe to the at least one wall.

2) The medicine cabinet safe system according to claim 1 wherein said at least one safe attacher comprises at least two bolts.

3) The medicine cabinet safe system according to claim 1 wherein said at least one safe attacher comprises at least one weld.

4) The medicine cabinet safe system according to claim 1 wherein said at least one wall mount comprises:
a) at least one fastener adapted to firmly attach said at least one lockable safe and said at least one medicine cabinet to the at least one wall;
b) wherein said at least one lockable safe and said at least one medicine cabinet are adapted to be penetrated and held in position by said at least one fastener.

5) The medicine cabinet safe system according to claim 4 wherein said wall mount further comprises:
a) at least one framing-stud reinforcement structured and arranged to reinforce the integrity of such at least one framing stud, when attached to such at least one framing stud; and
b) wherein said at least one fastener and said at least one framing-stud reinforcement are structured and arranged so that said at least one fastener, when attached with such at least one framing stud, will penetrate said at least one framing-stud reinforcement.

6) The medicine cabinet safe system according to claim 1 wherein said at least one lockable safe comprises at least one safe shelf structured and arranged to support such items, when such items are placed upon said at least one safe shelf.

7) The medicine cabinet safe system according to claim 6 wherein said at least one safe shelf is adjustable.

8) The medicine cabinet safe system according to claim 1 wherein said at least one lockable safe comprises at least one lock structured and arranged to lock said at least one lockable safe.

9) The medicine cabinet safe system according to claim 8 wherein said at least one lockable safe comprises at least one electronic-keypad lock structured and arranged to lock said at least one lockable safe.

10) The medicine cabinet safe system according to claim 8 wherein said at least one lockable safe comprises at least one fingerprint lock structured and arranged to lock said at least one lockable safe.

11) The medicine cabinet safe system according to claim 1 wherein said at least one lockable safe encloses about one-third of said at least one interior enclosable portion of said at least one medicine cabinet.

12) The medicine cabinet safe system according to claim 11 wherein said at least one lockable safe substantially encloses said at least one central portion of said at least one interior enclosable portion of said at least one medicine cabinet.

13) The medicine cabinet safe system according to claim 1 wherein said at least one lockable safe encloses about one-half of said at least one interior enclosable portion of said at least one medicine cabinet.

14) The medicine cabinet safe system according to claim 13 wherein said at least one lockable safe substantially encloses said at least one upper portion of said at least one interior enclosable portion of said at least one medicine cabinet.

15) The medicine cabinet safe system according to claim 13 wherein said at least one lockable safe substantially encloses said at least one lower portion of said at least one interior enclosable portion of said at least one medicine cabinet.

16) The medicine cabinet safe system according to claim 1 wherein said at least one lockable safe substantially encloses said at least one central portion of said at least one interior enclosable portion of said at least one medicine cabinet.

17) The medicine cabinet safe system according to claim 1 wherein said at least one lockable safe comprises substantially metal.

18) The medicine cabinet safe system according to claim 1 wherein:
a) said at least one medicine cabinet is substantially metal;
b) said at least one lockable safe is substantially metal;
c) said at least one medicine cabinet is about 14-inches wide, about 24-inches high and about 4-inches deep;
d) said at least one lockable safe comprises at least one safe shelf structured and arranged to support additional items;
e) said at least one safe shelf is adjustable; and
f) said at least one lockable safe comprises at least one lock structured and arranged to lock said at least one lockable safe.

19) A medicine cabinet safe monetizing method comprising the steps of:
a) providing a line of medicine cabinets each including at least one lockable safe located within and permanently mounted to at least one interior of at least one medicine cabinet of such line;
b) wherein such line includes a plurality of selectable sizes of such lockable safes and a plurality of selectable placements of such lockable safes within such at least one medicine cabinet;
c) receiving at least one order from at least one customer for such at least one medicine cabinet of such line;
d) providing such ordered at least one medicine cabinet to such at least one customer; and
e) receiving from such at least one customer, compensation for such ordered at least one medicine cabinet.

20) The medicine cabinet safe monetizing method according to claim 19 wherein such line further includes providing at least one lock selected from a plurality of selectable locks relating to such lockable safes.
